(19) United States
(12) Patent Application Publication
(10) Pub. No.: US 2025/0192203 A1
(43) Pub. Date: Jun. 12, 2025

(54) DEVICE AND METHOD FOR CONDITIONING AND PURGING AN ANODE OF A FUEL CELL STACK

(71) Applicant: Robert Bosch GmbH, Stuttgart (DE)

(72) Inventors: Anton Ringel, Bamberg (DE); Steffen Christa, Eltmann (DE); Tobias Wehner, Bamberg (DE)

(21) Appl. No.: 18/844,460

(22) PCT Filed: Mar. 20, 2023
(86) PCT No.: PCT/EP2023/057022

§ 371 Date: Sep. 6, 2024

(30) Foreign Application Priority Data
Mar. 24, 2022 (DE) 10 2022 202 915.1

(51) Int. Cl. H01M 8/04223; H01M 8/04082; H01M 8/04119

(52) U.S. Cl. CPC H01M 8/04231; H01M 8/04126; H01M 8/04201

(57) ABSTRACT

The invention relates to a device (1), in particular a test bench, for conditioning and purging an anode (2) of a preferably newly constructed cell stack (3), said device comprising:
a hydrogen store (4) connected to an anode inlet (7) via a gas line (5) having an integrated shut-off valve (6), wherein a conditioning device (8), preferably a humidifying device, is integrated into the gas line (5) between the shut-off valve (6) and the anode inlet (7),
an inert-gas store (9) connected to the gas line (5) via a purging line (10) which preferably has an integrated shut-off valve (11), wherein the purging line (10) joins the gas line (5) downstream of the conditioning device (8).

The invention also relates to a method for conditioning and purging an anode (2) of a preferably newly constructed fuel cell stack (3).

### BACKGROUND

The invention relates to a device and a method for conditioning and purging an anode of a preferably newly constructed fuel cell stack. In particular, the device may be a test bench.

A newly constructed fuel cell stack is usually subjected to a conditioning process before commissioning. This is to ensure that the fuel cell stack reaches its full capacity. Following the conditioning process, the fuel cell stack must first be cooled and then purged free of stress, wherein an inert gas, usually nitrogen, is used for purging. Only then can the newly constructed fuel cell stack be removed from the test bench.

During conditioning, hydrogen is fed to an anode of the fuel cell stack. During the subsequent purging process, any hydrogen present in the anode is expelled with the aid of the inert gas. To prevent hydrogen from flowing in, purging is carried out in a shutdown mode. This means that the hydrogen supply is shut off by means of a shut-off valve.

Purging is a time-consuming process, as the entire anode path used to supply hydrogen to the anode is purged. A process duration of 60 minutes is therefore not unusual. During this time, the test bench is occupied so that no further fuel cell stacks can be conditioned and purged.

The purpose of the present invention is to accelerate the purging process in order to shorten the expensive test bench time. The aim is to achieve a purging time of less than 10 minutes.

### SUMMARY

To solve the problem, the device according to the disclosure and the method according to the disclosure are proposed. Advantageous further embodiments of the invention are also described.

The proposed device for conditioning and purging an anode of a preferably newly constructed fuel cell stack comprises:
a hydrogen store which is connected to an anode inlet via a gas line with an integrated shut-off valve, wherein a conditioning device, preferably a humidifying device, is integrated into the gas line between the shut-off valve and the anode inlet,
an inert-gas store, which is connected to the gas line via a purging line, into which a shut-off valve is preferably integrated, wherein the purging line joins the gas line downstream of the conditioning device.

In particular, the device may be a test bench.

In the proposed device, the inert-gas store is connected to the anode of the fuel cell stack to be purged via a purging line, wherein the purging line joins the gas line downstream of the conditioning device. This means that the purging line bypasses the conditioning device. The joining of the purging line can thus be arranged in the area of the anode inlet, so that the entire anode path no longer has to be purged up to the anode inlet, but essentially only the anode itself. This reduces the volume to be purged, so that the purging time can be significantly shortened. Resources are also conserved as less hydrogen is expelled. The hydrogen remaining in the anode path can then be used in the next conditioning process.

According to a preferred embodiment of the invention, the purging line joins the gas line downstream of a valve unit which is integrated into the gas line downstream of the conditioning device and comprises a shut-off valve and/or a directional control valve. The valve unit can be used to separate the conditioning device from the volume to be purged. Disconnection can be achieved with either a shut-off valve or a directional control valve. Depending on the design of the device, the directional control valve can have further advantages. These are discussed further below.

It is also proposed that a further gas line is connected to an anode outlet. The hydrogen present in the anode can be drained or expelled via the further purging line on the anode outlet side. A further purging line preferably branches off from the gas line on the anode outlet side. The purging volume can be further reduced using the further purging line. This applies in particular if the further purging line branches off from the gas line on the anode outlet side directly in the area of the anode outlet. Preferably, the further purging line branches off upstream of a shut-off valve integrated into the gas line on the anode outlet side. By closing the shut-off valve, a self-contained reduced purging volume can be created.

In a further development of the invention, it is proposed that a directional control valve for switching a further purging line branching off from the anode-inlet-side purging line is integrated into the anode-inlet-side purging line, which joins the anode-inlet-side gas line upstream of the valve unit. Depending on the switching position of the directional control valve, the inert gas can then be fed into the gas line on the anode inlet side via one or the other purging lines. In this way, a further purging volume comprising the conditioning device can be connected to the inert-gas store so that the conditioning device can also be purged if required. In order to be able to purge the anode and the conditioning device independently of each other, one purging line joins the gas line on the anode inlet side downstream of the valve unit and the other purging line joins the gas line on the anode inlet side upstream of the valve unit. The valve unit then separates the two purging volumes.

A bypass line is also preferably provided to bypass the fuel cell stack. The bypass line also makes it possible to purge the conditioning device without having to include the anode of the fuel cell stack. The bypass line is preferably connected to the gas line on the anode inlet side via the valve unit and to the gas line on the anode outlet side via a further valve unit.

In addition, the inert-gas store can be connected to the gas line on the anode inlet side via a further purging line with an integrated shut-off valve, wherein the further purging line joins the gas line on the anode inlet side upstream of the conditioning device. The further purging line can be used to further reduce the purging volume of the conditioning device so that the purging of the conditioning device is accelerated.

Furthermore, the conditioning device can have a separate outlet with a connected gas line for inert gas. The separate outlet eliminates the need for a bypass line to bypass the fuel cell stack, as the inert gas used to purge the conditioning unit can be discharged directly via the outlet. The purging volume of the conditioning device can thus be further reduced.

In addition, a method for conditioning and purging an anode of a preferably newly constructed fuel cell stack is proposed. The method comprises the steps of:
conditioning of the anode with hydrogen, which is taken from a hydrogen store and fed to an anode inlet via a gas line, wherein the hydrogen is passed through a conditioning device, preferably a humidifying device,
purging the anode with an inert gas, which is taken from an inert-gas store and fed to the anode inlet via a purging line bypassing the conditioning device to expel the hydrogen from the anode.

Bypassing the conditioning device during purging reduces the purging volume, which can significantly shorten the purging process. The time during which the fuel cell stack must remain in a conditioning and purging device, which may be a test bench in particular, is reduced accordingly.

Preferably, when purging the anode with inert gas, the hydrogen store is separated from the anode by means of a shut-off valve and/or the conditioning device is separated from the anode by means of a valve unit. The separation results in a reduced and self-contained purging volume.

If required, the purging line can also be used for purging the conditioning unit. The inert gas required for purging can be fed to the conditioning device via a directional control valve integrated into the purging line and a branching purging line connected to it. A further purging volume comprising the conditioning device is then connected to the inert-gas store via the branching purging line. In order to separate this purging volume from the purging volume comprising the anode, the branching purging line preferably joins the gas line upstream of the valve unit. The valve unit thus separates the two purging volumes.

As an additional measure, it is proposed that the inert gas used to purge the conditioning device is discharged from the conditioning device via a separate outlet and a gas line connected to it. In this way, a further reduction in the purging volume of the conditioning device can be achieved.

Advantageously, the purging process is monitored with the aid of a high-frequency resistor. The monitoring can be used to check the result of the purging process in particular.

### BRIEF DESCRIPTION OF THE DRAWINGS

Advantageous embodiments of the invention are explained in more detail below with reference to the accompanying drawings. Shown are:

FIG. 1 a schematic representation of a first device according to the invention for conditioning and purging a fuel cell stack,

FIG. 2 a schematic representation of a second device according to the invention for conditioning and purging a fuel cell stack,

FIG. 3 a schematic representation of a third device according to the invention for conditioning and purging a fuel cell stack,

FIG. 4 a schematic representation of a fourth device according to the invention for conditioning and purging a fuel cell stack, and

FIG. 5 a schematic representation of a fifth device according to the invention for conditioning and purging a fuel cell stack.

### DETAILED DESCRIPTION

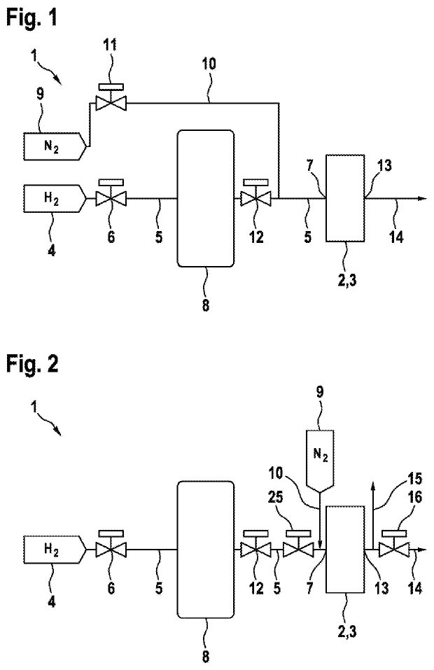

The device 1 shown in FIG. 1 is used for conditioning and purging an anode 2 of a newly constructed fuel cell stack 3. For this purpose, the device 1 has a hydrogen store 4, which is connected to an anode inlet 7 of the anode 2 via a gas line 5. A shut-off valve 6, a conditioning device 8 in the form of a humidifier column, and a valve unit 12 are integrated into the gas line 5. In addition, the device 1 has an inert-gas store 9, which is connected to the gas line 5 via a purging line 10, wherein the purging line 10 joins the gas line 5 downstream of the conditioning device 8 and the valve unit 12. The purging line 10 thus bypasses the conditioning device 8, so that the volume to be purged is significantly reduced. In this way, the purging process can be accelerated.

Purging anode 2 with inert gas takes place in shutdown mode. This means that at least the valve unit 12, preferably the valve unit 12 and the shut-off valve 6, is or are closed. A shut-off valve 11 integrated in the purging line 10, on the other hand, is open in order to remove inert gas from the inert-gas store 9.

The inert gas is used for expelling any hydrogen present in anode 2 during purging. The hydrogen and the inert gas exit via an anode outlet 13, to which a further gas line 14 is connected.

To further reduce the purging volume, the embodiment shown in FIG. 2 is proposed. Here, the inert-gas store 9 is located in the area of the anode inlet 7, so that the purging line 10 can be made particularly short. In the area of the anode outlet 13, a further purging line 15 branches off from the gas line 14 on the anode outlet side, via which the inert gas can be discharged. As the further purging line 15 branches off upstream of a shut-off valve 16 integrated into the gas line 14, a reduced and self-contained purging volume can be created. If required, a further shut-off valve 25 can be integrated into the gas line 5 on the anode inlet side, which is arranged even closer to the anode 2 than the valve unit 12, so that the purging volume is further minimized.

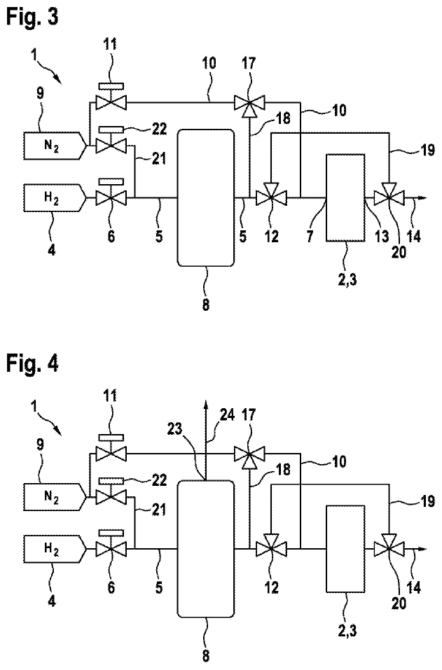

FIG. 3 shows a device 1 that combines various embodiments. The inert-gas store 9 is connected to the gas line 5 as shown in FIG. 1. In contrast to FIG. 1, however, a directional control valve 17 is integrated in the purging line 10, from which a further purging line 18 branches off, which also joins the gas line 5, but upstream of the valve unit 12. Depending on the switching position of the directional control valve 17 and the valve unit 12, inert gas can thus be fed from the inert-gas store 9 to the anode 2 or the conditioning device 8. The device 1 of FIG. 3 thus also enables purging of the conditioning device 8, independently of the anode 2.

In addition, FIG. 3 shows a bypass line 19, which serves to bypass the fuel cell stack 3. The inert gas used for purging the conditioning device 8 therefore does not have to be discharged via the anode 2 of the fuel cell stack 3. For this purpose, the bypass line 19 is connected to the gas line 5 on the anode inlet side via the valve unit 12 and a further valve unit 20 is connected to the gas line 14 on the anode outlet side. It therefore proves to be an advantage here if the valve unit 12 is designed as a directional control valve and not as a simple shut-off valve.

As shown by way of example in FIG. 3, a further purging line 21 may be present—as an alternative or in addition to the branching purging line 18—which connects the inert-gas store to the gas line 5, wherein the further purging line 21 joins the gas line 5 upstream of the conditioning device 8. The purging line 21 can therefore be used to further minimize the purging volume of the conditioning device 8. A shut-off valve 22 is integrated into the purging line 21 in order to be able to separate the inert-gas store 9 from the purging line 21.

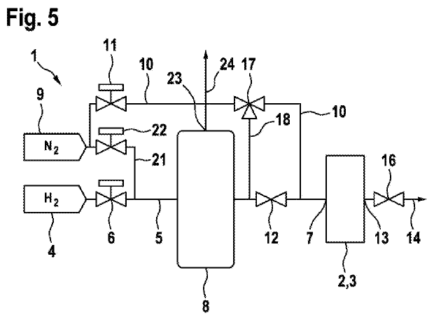

A further development of the embodiment in FIG. 3 is shown in FIG. 4. To further minimize the purging volume of the conditioning device 8, the conditioning device 8 has a separate outlet 23 with a gas line 24 connected to it. The bypass line 19 is therefore unnecessary. This embodiment is shown in FIG. 5. By dispensing with the bypass line 19, the valve unit 12 can be designed as a simple shut-off valve. The same applies to the valve unit 20.

1. A device (1) for conditioning and purging an anode (2) of a fuel cell stack (3), said device comprising:
a hydrogen store (4) connected to an anode inlet (7) via a gas line (5) having an integrated shut-off valve (6), wherein a conditioning device (8) is integrated into the gas line (5) between the shut-off valve (6) and the anode inlet (7),
an inert-gas store (9) connected to the gas line (5) via a purging line (10), wherein the purging line (10) joins the gas line (5) downstream of the conditioning device (8).

2. The device (1) according to claim 1,
wherein the purging line (10) joins the gas line (5) downstream of a valve unit (12), which is integrated into the gas line (5) downstream of the conditioning device (8) and comprises a shut-off valve and/or a directional control valve.

3. The device (1) according to claim 1,
wherein a further gas line (14) is connected to an anode outlet (13), from which a further purging line (15) branches off.

4. The device (1) according to claim 2, wherein a directional control valve (17) for switching a further purging line (18) branching off from the purging line (10) is integrated into the purging line (10) and joins the gas line (5) upstream of the valve unit (12).

5. The device (1) according to claim 1, wherein a bypass line (19) is provided for bypassing the fuel cell stack (3).

6. The device (1) according to claim 1, wherein the inert-gas store (9) is connected to the gas line (5) on an anode inlet side via a further purging line (21) with integrated shut-off valve (22), wherein the further purging line (21) joins the gas line (5) on the anode inlet side upstream of the conditioning device (8).

7. The device (1) according to claim 1, wherein the conditioning device (8) has a separate outlet (23) with a connected gas line (24) for inert gas.

8. A method for conditioning and purging an anode (2) of a fuel cell stack (3), said method comprising the following steps:
conditioning the anode (2) with hydrogen, which is taken from a hydrogen store (4) and fed to an anode inlet (7) via a gas line (5), wherein the hydrogen is passed through a conditioning device (8),
purging the anode (2) with an inert gas, which is taken from an inert-gas store (9) and fed to the anode inlet (7) via a purging line (10) bypassing the conditioning device (8) to expel the hydrogen from the anode (2).

9. The method according to claim 8,
wherein when purging the anode (2) with inert gas, the hydrogen store (4) is separated from the anode (2) by a shut-off valve (6) and/or the conditioning device (8) by a valve unit (12).

10. The method according to claim 8,
wherein the purging line (10) is also used for purging the conditioning device (8), wherein the inert gas required for purging is fed to the conditioning device (8) via a directional control valve (17) integrated in the purging line (10) and a branching purging line (18) connected to the directional control valve (17).

11. The method according to claim 10,
wherein the inert gas used for purging the conditioning device (8) is discharged from the conditioning device (8) via a separate outlet (23) and a gas line (24) connected thereto.

12. The method according to claim 8,
wherein the purging process is monitored by a high-frequency resistor.

13. The device (1) according to claim 1, wherein the device is a test stand.

14. The device (1) according to claim 1, wherein the conditioning device (8) is a humidifying device.

15. The device (1) according to claim 1, wherein the purging line (10 has an integrated shut-off valve (11).

16. The device (1) according to claim 3, wherein the further purging line (15) branches off upstream of a shut-off valve (16) integrated in the gas line (14).

17. The device (1) according to claim 5, wherein the bypass line (19) is connected via a valve unit (12) to the gas line (5) on an anode inlet side, and via a further valve unit (20) to a further gas line (14) on an anode outlet side.

18. The method according to claim 8, wherein the conditioning device (8) is a humidifying device.
